(19) United States
(12) Patent Application Publication
(10) Pub. No.: US 2023/0123404 A1
(43) Pub. Date: Apr. 20, 2023

(54) MATERIALS WITH VARYING FLEXURAL MODULUS

(71) Applicant: Tyler Andre Kafentzis, Richland, WA (US)

(72) Inventor: Tyler Andre Kafentzis, Richland, WA (US)

(73) Assignee: Epsitek LLC, Richland`, WA (US)

(21) Appl. No.: 17/502,623

(22) Filed: Oct. 15, 2021

(51) Int. Cl. D03D 15/47; D06M 15/19; D03D 15/573; D03D 15/56; B32B 3/28; B32B 3/12; B32B 5/02

(52) U.S. Cl. CPC D03D 15/47; D06M 15/19; D03D 15/573; D03D 15/56; B32B 3/28; B32B 3/12; B32B 5/024; D06M 2200/40; B32B 2255/02; B32B 2307/546; B32B 2307/54

(57) ABSTRACT

This invention relates generally to flexible materials, especially those made of carbon fiber. The materials exhibit a first flexural modulus over a first range of flexural strain and a second flexural modulus over a second range of flexural strain. The materials provide advantages when used in an article of manufacture in which the performance may be improved by having a different flexural modulus depending on the amount of flexural strain, and thus dislocation, of the material.

### TECHNICAL FIELD

This invention relates generally to flexible materials. Among other uses, the present invention may provide a material that exhibits a first flexural modulus over a first range of flexural strain and a second flexural modulus over a second range of flexural strain.

### BACKGROUND OF THE INVENTION

Many solid materials exhibit a flexural modulus when exposed to a flexural strain. Some materials exhibit an increasing flexural modulus when exposed to an increasing flexural strain. Some materials exhibit an exponential increase in flexural modulus when exposed to an increasing flexural strain. There also exist a variety of applications wherein it is desirable to use a material that exhibits a first flexural modulus over a first range of said flexural strain and a second flexural modulus over a second range of said flexural strain. Among other advantages, and not meant to be limiting, the present invention provides that capability.

### SUMMARY OF THE INVENTION

The present invention may include a material comprising woven tows, a substrate, and a polymer. Each tow may consist of a bundle of fibers, and the tows may be woven such that each tow is alternately in a distal position, wherein they are in contact with a tow in a proximal position, and in a proximal position, wherein they are in contact with both the substrate and with a tow in a distal position. The fibers may be any fibers having a monofilament tensile strength of at least 10 ksi, including without limitation, carbon fibers, polymer fibers, aramid fibers, metallic fibers, shape memory fibers, and glass fibers.

As used herein, the term “alternately” means that the tows are sometimes in the distal position, and sometimes in the proximal position, and is intended to include all weaving patterns where a tow is sometimes in the distal position and sometimes in the proximal position. Accordingly, all weaving patterns and combinations thereof are included in this definition, including, without limitation, plain weaves (sometimes called “tabby” weaves), rib weaves, basket weaves, herringbone weaves, twill weaves, satin weaves, sateen weaves, leno weaves, Oxford weaves, Bedford cord weaves, waffle weaves, pile weaves, crepe weaves, lappet weaves, tapestry weaves, striped weaves, Checquered weaves, dobby weaves, jacquard weaves, double weaves, double cloth weaves, swivel weaves, tablet weaves, tri-axial weaves, multi-axial weaves, and combinations thereof.

The material of the present invention may include one or more regions that are intended to be flexed as a part of the material's intended use, and may further include one or more regions that are not intended to be flexed as part of the materials intended use.

In the present invention, in at least one of the regions that that are intended to be flexed as a part of the materials intended use, the polymer substantially fails to form a bond between the distal portion of the tows and the proximal portion of the tows, or forms a bond that subsequently fails, but substantially does form a bond between the proximal portion of the tows and the substrate and further substantially forms a bond between the fibers in each tow. As used herein, the term “substantially” means that at least one region that is intended to be flexed as a part of the material's intended use, the locations where there is an interface between the distal portion of the tows and the proximal portion of the tows, the polymer fails to form a bond, or forms a bond that subsequently fails, between the distal portion of the tows and the proximal portion of the tows, in at least fifty percent of those locations. Similarly, as used herein, the term “substantially” means within at least one region that is intended to be flexed as a part of the material's intended use where there is an interface between the proximal portion of the tows and the substrate, the polymer forms a bond between the tows and the substrate in at least fifty percent of those locations. Also, as used herein, the term “substantially” means that among the fibers in each tow, the polymer forms a bond between at least fifty percent of the fibers. As will be recognized by those having skill in the art, when the material is flexed, adjacent fibers in each tow impart a shear stress to the polymer forming a bond between them. As used herein, substantially” further means that among the fibers in each tow, when the material is flexed and shear forces are applied to the polymer that forms a bond between adjacent fibers, at least fifty percent of those bonds do not fail. Preferably, all of the adjacent fibers are coated with the polymer, and thereby do not come in contact with one and another, thereby avoiding any abrasive action between adjacent fibers within each tow.

In one embodiment of the present invention, the polymer is a sizing that is applied to the fibers before they are woven together.

In one embodiment of the present invention, the polymer is selected as having a one hundred percent secant tensile modulus of between 50 and 1,000 psi. As used herein, the secant tensile modulus is a method used to calculate modulus of elasticity, which is a measurement of a material's elasticity. Calculating secant modulus involves using two points on a stress-strain curve to calculate the slope of the stress/strain. The first point is always zero and the second is always a non-zero value. For example, if secant modulus is calculated at 100% tensile strain, the formula for the calculation is: Secant Tensile Modulus=(σ2−σ1)/(ε2−ε1)=(Stress @ 100% Strain−0)/(100% Strain−0).

In one embodiment of the present invention, the polymer is selected as having a one hundred percent secant tensile modulus of between 80 to 200 psi.

In one embodiment of the present invention, the durometer of the polymer is between shore A 10 and shore A 100. As used herein, the durometer is measured consistent with the ASTM D2240-00 testing standard.

In one embodiment of the present invention, the polymer is a thermoplastic applied to the woven tows.

In one embodiment of the present invention, the thermoplastic is selected as having a one hundred percent secant tensile modulus of between 50 and 1,000 psi.

In one embodiment of the present invention, the thermoplastic is selected as having a one hundred percent secant tensile modulus of between 80 to 200 psi.

In one embodiment of the present invention, the durometer of the thermoplastic is between shore A 10 and shore A 100.

In one embodiment of the present invention, when an increasing amount of flexural strain is applied to the material in a given direction, beginning with the initiation of flexural strain and ending with the failure of the material, the material may exhibit a first flexural modulus over a first range of the flexural strain and a second flexural modulus over a second range of the flexural strain. In this embodiment, the second flexural modulus may be at least twice the first flexural modulus, and the first and second ranges of flexural strain may be at least half of the range of flexural strain from initiation of flexural strain to the failure of the material.

In one embodiment of the present invention, dislocations may be formed in the tows at the locations where the polymer either does not form a bond or substantially fails between the distal portion of the tows and the proximal portion of the tows by bending the material to compress the tows at those locations.

In one embodiment of the present invention, the material may exhibit a first flexural modulus over a range of positions where the material exhibits dislocations, and a second flexural modulus over a range of positions where the material does not exhibit dislocations.

In one embodiment of the present invention, the substrate may be selected from the group consisting of materials having more than one layer, materials having a rigid layer, materials formed of a single layer, and materials having at least one layer with a structural geometry.

In the embodiment of the present invention wherein the substrate is selected as a material having at least one layer with a structural geometry, the structural geometry may be selected from a corrugated structural geometry, a honeycomb structural geometry, and combinations thereof.

In one embodiment of the present invention, the material is integrated into an item of manufacture.

In the embodiment of the present invention wherein the material is integrated into an article of manufacture, while not meant to be limiting, the article may be an article that enhances athletic performance, including but not limited to, shoes, skates, boots, snowboards, and skis; an article used in medical devices, including but not limited to, braces, casts, slings, or other devices to control stiffness over a range of motion; an article used to protect a human being, including but not limited to helmets, pads, guards, and gloves; an article used in mechanical devices including but not limited to buckles, hinges, mounts, blinds, springs, gaskets, and dampening devices; and other articles of manufacture whose performance may be enhanced by the properties of the invention as described herein.

In one embodiment of the present invention, the substrate includes at least one intermediary layer that may displace the flexural neutral axis of the material away from the woven tows.

In one embodiment of the present invention, the displacement of the flexural neutral axis of the material away from the woven tows may occur as a result of dislocation or engagement of the tows.

In one embodiment of the present invention, a portion of the material may exhibit dislocations in a first portion of the tows and may not exhibit dislocations in a second portion of the tows when the material is not under strain.

### BRIEF DESCRIPTION OF THE DRAWINGS

The following detailed description of the embodiments of the invention will be more readily understood when taken in conjunction with the following drawing, wherein:

FIG. 1 is an illustration of one embodiment of the present invention.

FIG. 2 is an illustration of a cross section of the embodiment of the present invention shown in FIG. 1.

FIG. 3 is an illustration of a cross section of the embodiment of the present invention shown in FIG. 1 where the tows have been dislocated in two positions.

FIG. 4 is a graph showing a first flexural modulus over a first range of the flexural strain and a second flexural modulus over a second range of the flexural strain.

FIG. 5 is an illustration of one embodiment of the present invention showing the dislocations of the tows caused by the compression of the tows due to the flexing of the material.

FIG. 6 is an illustration of one embodiment of the present invention where the substrate has more than one layer.

FIG. 7 is an illustration of one embodiment of the present invention where the substrate has more than one layer and one of the layers has a honeycomb structure.

FIG. 8 is an illustration of one embodiment of the present invention where the substrate has more than one layer and one of the layers has a corrugated structure.

FIG. 9 is an illustration of two adjacent strands of fiber in an embodiment of the present invention showing the polymer as not experiencing shear stress.

FIG. 10 is an illustration of two adjacent strands of fiber in an embodiment of the present invention showing the polymer as experiencing shear stress.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

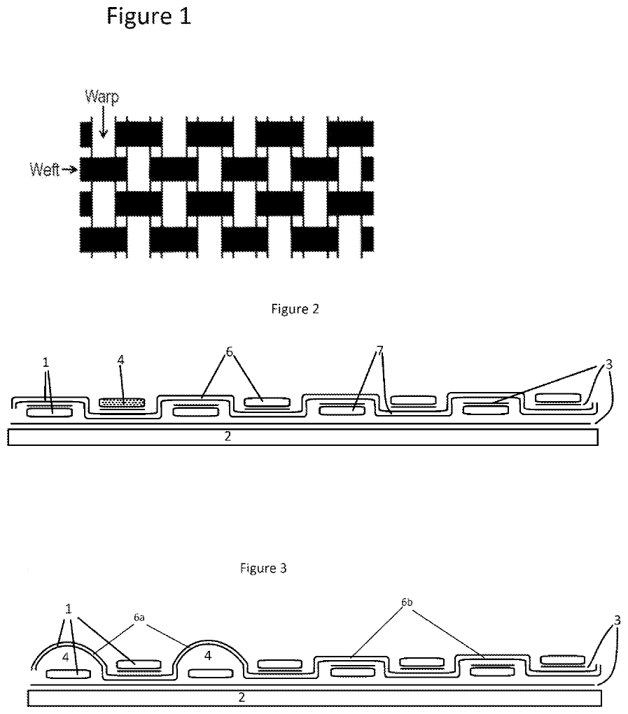

One exemplary embodiment of the present invention is shown in FIG. 1 and FIG. 2. FIG. 1 shows a plain weave, with warp and weft tows at a ninety degree angle to one and another, alternating back and forth. FIG. 2 is the same plain weave as a cutaway view. Neither figure is drawn to scale.

As shown in FIG. 2, the present invention may include a material comprising woven tows 1, a substrate 2, and a polymer 3. Each tow 1 may consist of a bundle of fibers 4. For illustrative purposes, only one of the tows 1 in the figure is shown as a bundle of fibers 4. The tows 1 may be woven such that each tow is alternately in a distal position 6, wherein they are in contact with a tow in a proximal position 7, and in a proximal position 7, wherein they are in contact with both the substrate 2 and with a tow in a distal position 6.

As shown in FIGS. 1 and 2, the tows are sometimes in the distal position 6, and sometimes in the proximal position 7. While FIGS. 1 and 2 show a plain weave, those of ordinary skill in the art will recognize that it is common in weaving patterns for a tow to sometimes be in the distal position and sometimes in the proximal position. Accordingly, while FIGS. 1 and 2 show a plain weave, all weaving patterns and combinations thereof should be understood to be included in the invention, including without limitation, plain weaves (sometimes called “tabby” weaves), rib weaves, basket weaves, herringbone weaves, twill weaves, satin weaves, sateen weaves, leno weaves, Oxford weaves, Bedford cord weaves, waffle weaves, pile weaves, crepe weaves, lappet weaves, tapestry weaves, striped weaves, Checquered weaves, dobby weaves, jacquard weaves, double weaves, double cloth weaves, swivel weaves, tablet weaves, tri-axial weaves, and multi-axial weaves.

FIG. 3 is the same illustrative example as FIG. 2, except that in FIG. 3, two of the tows 1 in the distal position 6a are shown as exhibiting dislocations 4, and two of the tows 1 in the distal position 6b are shown as not exhibiting dislocations 4. Since the tows that are shown as not exhibiting dislocations 4, they are also shown as not having the polymer 3 in between the distal portion of the tows and the proximal portion of the tows.

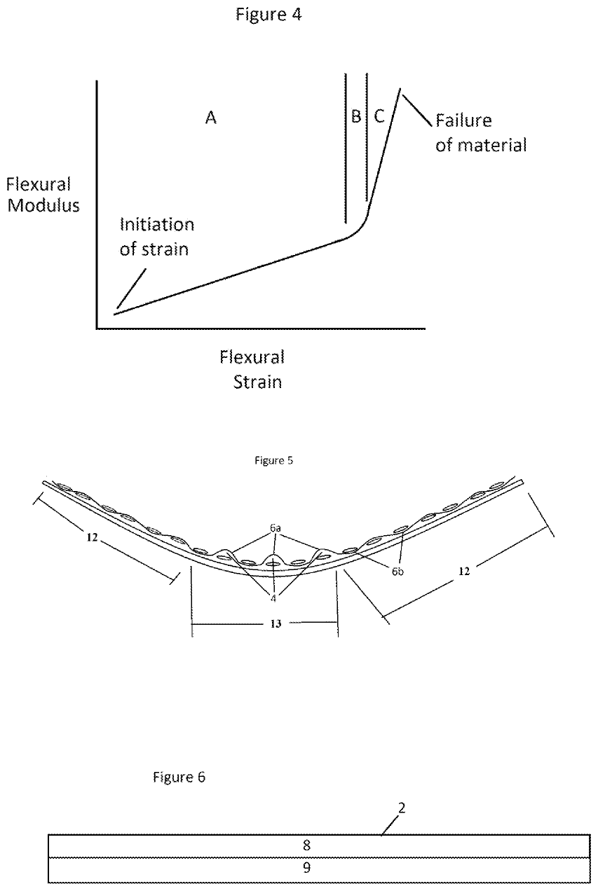

FIG. 4 is a graph showing the relationship between the flexural strain applied to the material of the present invention and the flexural modulus exhibited by the material. As shown in the graph of FIG. 4, when an increasing amount of flexural strain is applied to the material in a given direction, beginning with the initiation of flexural strain and ending with the failure of the material, the material may exhibit a first flexural modulus over a first range of flexural strain, shown in the graph as region A, a second flexural modulus over a second range of flexural strain, shown in the graph as region B, and a third range of flexural modulus over a third range of flexural strain, shown in the graph as region C. As shown in the graph of FIG. 4, both regions A and C are substantially linear, meaning the slope changes by less than a factor of two, and region B is non-linear, meaning the slope changes by a factor of two or more. As is also shown in the graph of FIG. 4, the third range of flexural modulus C has more than twice the slope of A, indicating that the increase of flexural modulus in region C as a function of applied strain is more than twice the increase in flexural modulus in region A as a function of applied strain. As is also shown in the graph of FIG. 4, the regions A and C, where the increase of flexural modulus as a function of applied strain is linear, comprise the majority of the range of flexural strain from initiation of flexural strain to the failure of the material. Region B, where the increase of flexural modulus as a function of applied strain is non-linear, comprises only a small portion of the range of flexural strain from initiation of flexural strain to the failure of the material.

FIG. 5 shows an embodiment of the present invention where dislocations are formed in the tows at the locations where the polymer substantially fails between the distal portion of the tows and the proximal portion of the tows 4 by bending the material to compress the tows at those locations. As is further shown in FIG. 5, there are two regions 12 wherein the material is not intended to be flexed as part of the materials' intended use, and there is one region 13 wherein the material is intended to be flexed as part of the materials' intended use.

As shown in FIG. 6, the substrate 2 may have more than one layer, shown as layer 8 and layer 9.

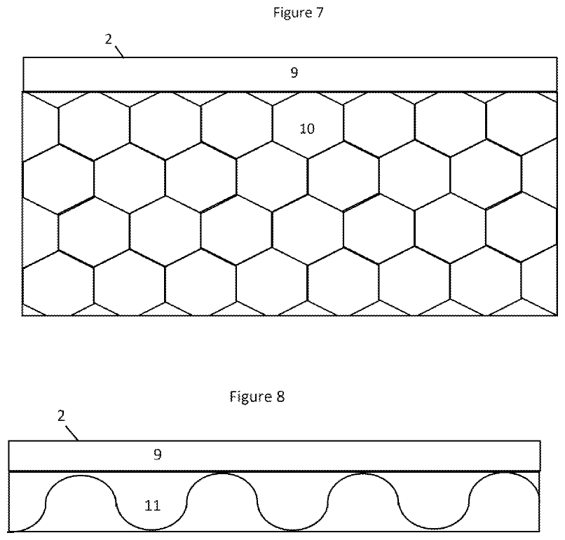

As shown in FIG. 7, the substrate 2 may have at least one layer with a structural geometry, the structural geometry may be selected from a corrugated structural geometry, a honeycomb structural geometry, and combinations thereof. FIG. 7 shows a honeycomb structural geometry 10. FIG. 8 shows a corrugated structural geometry.

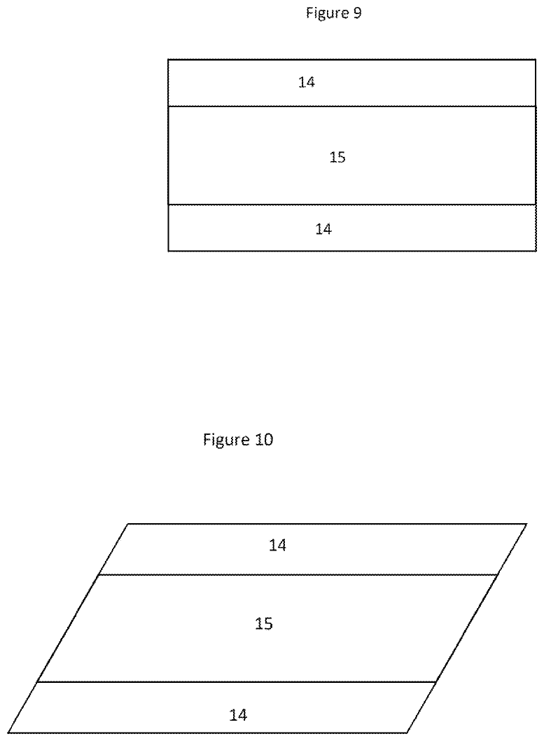

FIG. 9 shows two adjacent strands of fiber 14 in a tow in a non-stressed configuration wherein the polymer 15 is not experiencing shear stress.

FIG. 10 shows two adjacent strands of fiber 14 in a tow in a stressed configuration, which may be caused by flexing the material, wherein the polymer 15 is experiencing shear stress. As shown in FIG. 10, the bond between the polymer 15 and the fibers 14 are not failing.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. All publications, patents, and patent applications cited in this specification are herein incorporated by reference to the extent not inconsistent with the present disclosure as if each were specifically and individually indicated to be incorporated by reference and set forth in its entirety herein.

1. A material comprising woven tows, a substrate, and a polymer wherein each tow is a bundle of fibers and the tows are woven such that each tow is alternately in a distal position wherein they are in contact with a tow in a proximal position and in a proximal position wherein they are in contact with the substrate and with a tow in a distal position and wherein the polymer substantially fails between the distal portion of the tows and the proximal portion of the tows but does not substantially fail between the proximal portion of the tows and the substrate and does not substantially fail between the fibers in each tow.

2. The material of claim 1 wherein the polymer is a sizing applied to the fibers before they are woven together.

3. The material of claim 2 wherein the polymer is selected as having a one hundred percent secant tensile modulus of between 50 and 1,000 psi.

4. The material of claim 2 wherein the polymer is selected as having a one hundred percent secant tensile modulus of between 80 to 200 psi.

5. The material of claim 2 wherein the durometer of the polymer is shore A 10 to shore A 100.

6. The material of claim 1 wherein the polymer is a thermoplastic applied to the woven tows.

7. The material of claim 6 wherein the thermoplastic is selected as having a one hundred percent secant tensile modulus of between 50 and 1,000 psi.

8. The material of claim 6 wherein the thermoplastic is selected as having a one hundred percent secant tensile modulus of between 80 to 200 psi.

9. The material of claim 6 wherein the durometer of the thermoplastic is shore A 10 to shore A 100.

10. The material of claim 1 wherein when an increasing amount of flexural strain is applied to the material in a direction, beginning with the initiation of flexural strain and ending with the failure of the material, the material exhibits a first flexural modulus over a first range of said flexural strain and a second flexural modulus over a second range of said flexural strain, wherein the second flexural modulus is at least twice the first flexural modulus, wherein and the first and second ranges of flexural strain are at least half of the range of flexural strain from initiation of flexural strain to the failure of the material.

11. The material of claim 6 wherein when an increasing amount of flexural strain is applied to the material in a direction, beginning with the initiation of flexural strain and ending with the failure of the material the material exhibits a first flexural modulus over a first range of said flexural strain and a second flexural modulus over a second range of said flexural strain, wherein the second flexural modulus is at least twice the first flexural modulus, wherein and the first and second ranges of flexural strain are at least half of the range of flexural strain from initiation of flexural strain to the failure of the material.

12. The material of claim 1 wherein dislocations may be formed in the tows at the locations where the polymer substantially fails between the distal portion of the tows and the proximal portion of the tows by bending the material to compress the tows at said locations.

13. The material of claim 12 wherein the material exhibits a first flexural modulus over a range of positions where the material exhibits dislocations, and a second flexural modulus over a range of positions where the material does not exhibit dislocations.

14. The material of claim 1 wherein the substrate is selected from the group consisting of materials having more than one layer, materials having a rigid layer, materials formed of a single layer, materials having at least one layer with a structural geometry.

15. The material of claim 14 wherein the substrate selected as materials having at least one layer with a structural geometry, the structural geometry is selected from corrugated and honeycomb.

16. The material of claim 1 wherein the material is integrated into an item of manufacture.

17. The material of claim 16 wherein the article of manufacture is selected from shoes, skates, boots, snowboards, skis, medical devices, braces, casts, slings, helmets, pads, guards, gloves, buckles, hinges, mounts, blinds, springs, gaskets, and dampening devices.

18. The material of claim 14 wherein the substrate includes an intermediary layer that may displace the flexural neutral axis of the material away from the woven tows.

19. The material of claim 18 wherein the displacement of the flexural neutral axis of the material away from the woven tows occurs as a result of dislocation or engagement of the tows.

20. The material of claim 1 wherein a portion of the material exhibits dislocations in a first portion of the tows and does not exhibit dislocations in a second portion of the tows when the material is not under strain.
